(19) United States
(12) Patent Application Publication
(10) Pub. No.: US 2004/0230904 A1
(43) Pub. Date: Nov. 18, 2004

(54) Information display apparatus and information display method

(76) Inventor: Kenichiro Tada, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/805,474

(22) Filed: Mar. 22, 2004

(30) Foreign Application Priority Data
Mar. 24, 2003 (JP) 2003-080182

(51) Int. Cl. G06F 17/21

(52) U.S. Cl. 715/517

(57) ABSTRACT

An information display apparatus (1) includes a distance measuring unit (6) for measuring the distance between the apparatus and the remote controller (5) and a control unit for determining in advance the optimal size of the characters to be displayed in a text display area (2B) as a function of the distance between the apparatus and the remote controller (5) and controlling the size (X) of the characters to be displayed in the text display area (2B) with the predetermined optimal size of characters based on the result of the distance measuring unit (6). Since the user of the remote controller (5) is located at the position where the user (viewer) watches the information display apparatus (1), the size (X) of the characters to be displayed is automatically and optimally controlled according to the distance (R) between the remote controller (5) and the information display apparatus (1) regardless if the distance between the user (viewer) and the information display apparatus (1) changes.

### BACKGROUND OF THE INVENTION

1. Field of the Invention

This invention relates to an information display apparatus and an information display method.

2. Description of Related Art

Viewers may watch the image being displayed on the screen of an information display apparatus such as a television set from a position considerably separated from the apparatus. Therefore, a remote controller is normally provided for the convenience of the viewers so that any viewer can switch the image being displayed and/or change the volume of the sound being heard by the remote controller.

Certain information display apparatus have a text display area, through which viewers can see web pages.

Many information display apparatus of such a type use only given size of characters (fonts) displayed on the screen regardless of the distance separating the viewer and the display screen of the apparatus. Many viewers may watch the image or the text being displayed on the display screen of the information display apparatus at a variable distance. The viewer may feel it difficult to read the text being displayed in the text display area of the display screen when he or she is located at a position separated by a relatively long distance from the display screen.

Therefore, there is a demand for information display apparatus that can change the size of the characters being displayed. Some information display apparatus are provided with a feature of allowing the viewer manually to select an optimal font for the text of the web page being displayed in the text display area while others automatically change the size of the font according to the size of the display screen of the personal computer (Prior Art Document 1: Japanese Patent Laid-Open Publication No. Hei7-261724, pp. 3-5 and FIG. 1).

With the prior art that allows the user to manually change the font size, the viewer needs to change the font size each time the viewer moves and changes the distance separating the information display apparatus from him or her. Therefore, the problem of inconvenience on the part of the viewer is not dissolved.

When the font size is automatically changed according to the size of the display screen in Prior Art 1, the font size is not changed if the viewer changes his or her position. Therefore, the problem of inconvenience is not dissolved either.

### SUMMARY OF THE INVENTION

An object of the present invention is to provide an information display apparatus and an information display method that can automatically optimize the size of the characters being displayed regardless of the distance separating the display screen of the apparatus and the viewer.

According to an aspect of the present invention, an information display apparatus having a text display area for displaying a text according to the signal transmitted from a remote controller, the apparatus including: a distance measuring unit for measuring the distance between the apparatus and the remote controller; and a control unit for determining the size of the characters to be displayed in the text display area with the predetermined optimal size of characters based on the result of the distance measuring unit according to the predetermined relationship between distance from the apparatus to the remote controller and optimal size of the characters.

According to another aspect of the present invention, there is provided an information display method for displaying a text according to the signal transmitted from a remote controller. The method includes the step of: determining the size of the characters to be displayed in the text display area with the predetermined optimal size of characters based on the result of the distance measuring unit according to the predetermined relationship between distance from the apparatus to the remote controller and optimal size of the characters.

### BRIEF DESCRIPTION OF THE DRAWINGS

FIG. 1 is a perspective view showing a schematic configuration of an information display apparatus according to an embodiment of the present invention;

FIG. 2 is a block diagram showing an internal configuration of the information display apparatus;

FIG. 3 is a block diagram showing an internal configuration of a CPU that operates as a control unit;

FIG. 4 is a schematic illustration of the operation of photodetectors;

FIG. 5 is a schematic view of a triangle illustrating the positional relationship of a remote controller and a pair of photodetectors;

FIG. 6 is a schematic illustration showing the relation between the distance and the size of the characters;

FIGS. 7A through 7C are graphs illustrating the correlation of the size of the characters to be displayed and the distance;

FIG. 8 is a front view showing an outer configuration of a remote controller;

FIG. 9 is a block diagram showing an internal configuration of the remote controller;

FIG. 10 is a flowchart showing the basic procedure for controlling the size of the characters to be displayed;

FIGS. 11A through 11C are schematic illustrations of the display screen, showing how the size of the characters to be displayed are controlled according to the flowchart of FIG. 10;

FIG. 12 is a flowchart showing the procedure for controlling the size of the characters to be displayed according to a non-linear graph;

FIG. 13 is a flowchart showing the procedure for initializing the size of the characters to be displayed; and

FIGS. 14A through 14C are schematic illustrations of the display screen, showing how the size of the characters to be displayed are initialized according to the flowchart of FIG. 13.

### DETAILED DESCRIPTION OF PREFERRED EMBODIMENT(S)

Now, an embodiment of the present invention will be described in greater detail by referring to the accompanying drawings.

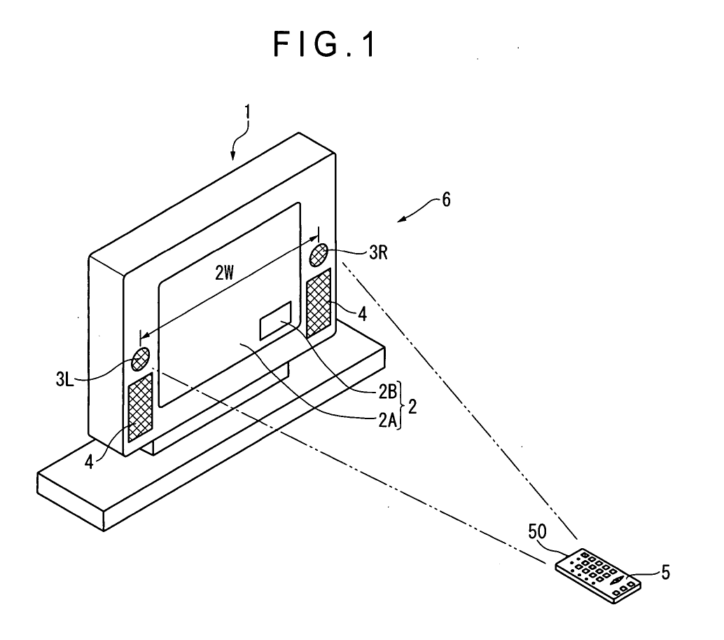

FIG. 1 is a perspective view illustrating a schematic configuration of an information display apparatus 1 according to the present embodiment.

Referring to FIG. 1, the information display apparatus 1 is a television set having a display screen 2 arranged at the front side thereof, a pair of photodetectors 3R, 3L arranged oppositely at respective lateral positions with the display screen 2 interposed between them and a loudspeaker 4. The information display apparatus 1 is controlled by a remote controller 5 in terms of sound and image. The remote controller 5 has a light emitting device 50 to transmit optical signals to the photodetectors 3R, 3L.

The display screen 2 includes an image display area 2A for displaying images and a text display area 2B arranged in a window provided with the image display area 2A. The information display apparatus 1 receives signal-carrying television waves of VHF and/or UHF and displays images in the image display area 2A. The displayed images include still images, moving images and characters and the like. The information display apparatus 1 also receives a signal from an external communication section such as the Internet, a cable television system or the like and displays texts in the text display area 2B. The texts displayed in the text display area 2B may be linked with the images displayed in the image display area 2A.

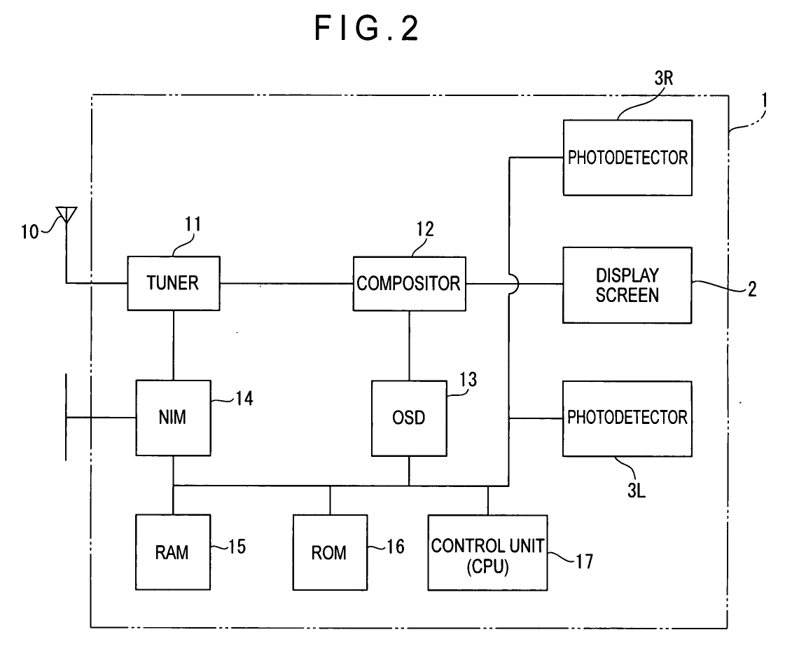

FIG. 2 is a block diagram illustrating an internal configuration of the information display apparatus 1.

Referring to FIG. 2, the information display apparatus 1 includes an antenna 10 for receiving television waves, a tuner 11 for tuning in the television waves received by the antenna 10 to provide image information and sound information, a compositor 12 for receiving signals from the tuner 11 and supplying edited information to the display screen 2, an OSD (on screen display) 13 for controlling the compositor 12, an NIM (network interface module) 14 for receiving a text from the external communication section such as the Internet, a cable television system or the like, a television RAM 15, a television ROM 16, and a CPU 17 that operates as a control unit for controlling the operations of driving the tuner 11, the compositor 12, the OSD 13, the NIM 14, the RAM 15 and the ROM 16. The CPU 17 transmits signals to the OSD 13 and the loudspeaker 4 so as to cause them to output images and sounds respectively and properly for television and optimally controls the size of the characters in response to the signals from the photodetectors 3R, 3L.

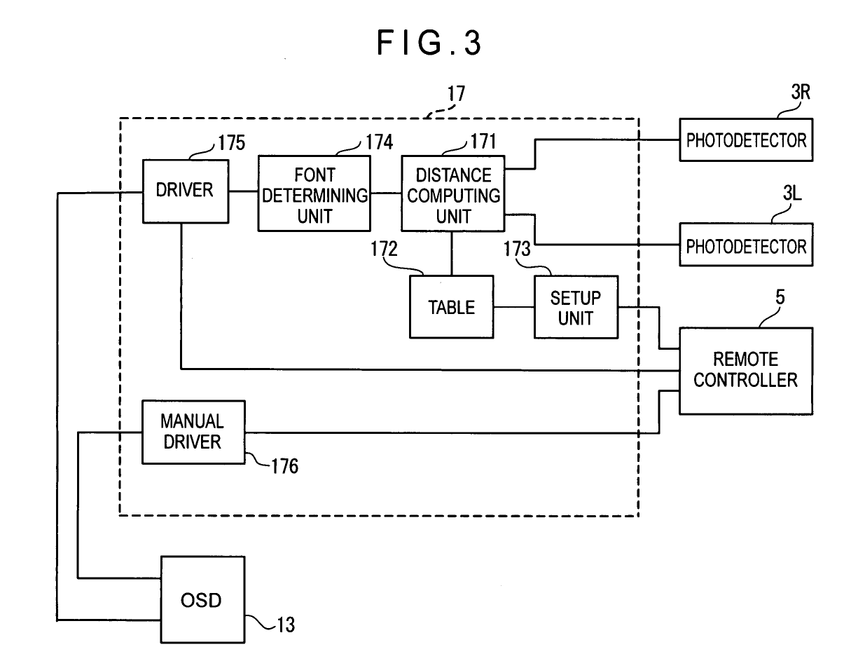

FIG. 3 illustrates the concrete configuration of the CPU 17.

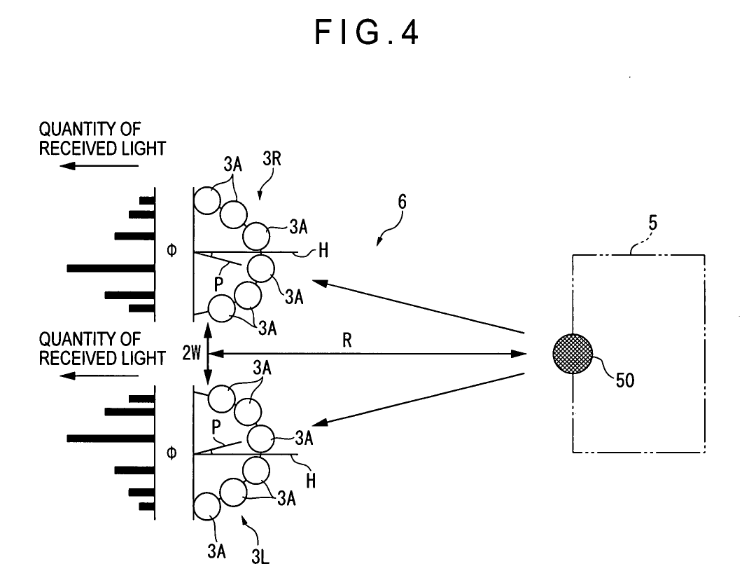

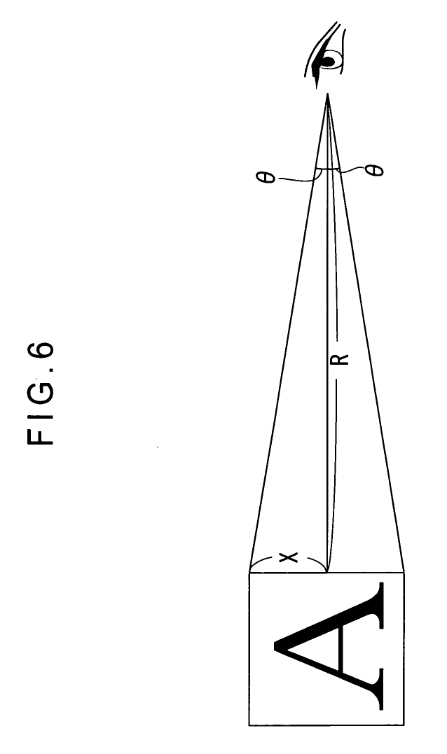

Referring to FIG. 3, the CPU 17 includes a distance computing unit 171 that receives signals from the photodetectors 3R, 3L, a table 172 illustrating the relationship between the distance R (see FIG. 4) from the information display apparatus 1 to the remote controller 5 and the optimal size X (see FIG. 6) of the characters (font) to be displayed in the text display area 2B, a setup unit 173 that receives the signals from the remote controller 5 and inputs data into the table 172, a font determining unit 174 that computationally determines the optimal size of the characters to be displayed on the basis of the table 172 and the data from the distance computing unit 171, a driver 175 that receives signal from the font determining unit 174 and transmits a signal for selecting the right size of the characters to be displayed in the text display area 2B to the OSD 13 and a manual driver 176 that receives the signals from the remote controller 5 and transmits a signal to be used for manual selection of the size of the characters to be displayed in the text display area 2B.

A distance measuring unit 6 of this embodiment that measures the distance between the information display apparatus 1 and the remote controller 5 is constituted by the photodetectors 3R, 3L and the distance computing unit 171.

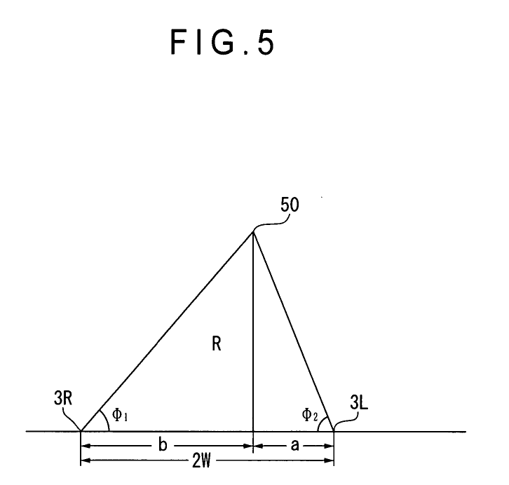

FIGS. 4 and 5 illustrate the distance measuring unit 6. FIG. 4 shows a schematic configuration of the photodetectors 3R, 3L.

Referring to FIG. 4, the distance measuring unit 6 is an optical range finder that receives optical signals emitted from the light emitting device 50 of the remote controller 5 and measures the distance R between the information display apparatus 1 and the remote controller 5. More specifically, it determines the distance R on the basis of the triangle defined by the photodetectors 3R, 3L and the remote controller 5 as the shortest line segment connecting a point on the line segment connecting the photodetectors 3R, 3L and the remote controller 5.

Each of the photodetectors 3R, 3L is formed by an arc-shaped array of light receiving devices 3A that are arranged on a horizontal plane. The distribution of intensity of light received by each of the light receiving devices 3A is proportional to the distance between the light emitting device 50 and the right receiving device 3A. Differently stated, the intensity of light received by a light receiving device 3A located close to the light emitting device 50 is higher than that of light received by a light receiving device 3A located remote from the light emitting device 50. In other words, the light receiving device 3A whose optical signal shows the highest directivity is the device whose intensity of received light is highest. The signal from the light receiving device 3A whose intensity of received light is highest is transmitted to the distance computing unit 171. The signal is also kept in the light receiving device 3A until the light receiving device 3A receives light with different intensity.

Now, the user of the remote controller 5 is located at the position where the remote controller 5 is located. Assume that the user (viewer) is right in front of the display screen 2, or on the normal line to the line segment connecting the photodetectors 3R, 3L that is extending from the mid point of the line segment and that the angle of deflection formed by the normal line H extending from the center of the arc shaped array of light receiving devices of each of the photodetectors 3R, 3L and the line segment P connecting the origin of the normal line H and the light receiving device 3A showing the highest directivity of the array is Φ, the equation of tan Φ=W/R holds true.

The angle Φ can be determined by the photodetectors 3R, 3L and the distance W is known and hence it is possible to determine the distance R between the display screen 2 and the remote controller 5.

If the user (viewer) is not located right in front of the display screen 2, it is possible to determine the distance R on the basis of the relationship of the triangle shown in FIG. 5.

More specifically, assume that the user is located on the normal line originating from a point on the line segment connecting the photodetectors 3R, 3L that shows a ratio of a:b. Then, equations of tan Φ1=R/b, tan Φ2=R/a, R=b tan Φ1=a tan Φ2 and b =a (tan Φ2/tan Φ1) hold true. On the other hand, a+b=2W and hence it is possible to determine R by determining a from the equation of a+a (tan Φ2/tan Φ1=2W and the angles of deflection Φ1 and Φ2 that are determined respectively for the photodetectors 3R, 3L.

The table 172 is a memory section for storing in advance the relationship between the distance R and the character size (the visual angle). FIG. 6 shows the relation between the distance R and the character size X. Referring to FIG. 6, if the user (viewer) views character (A) that is exactly enclosed in a square whose side is as long as 2X from a point separated by distance R from the text display area 2B, then the size X of the character to be displayed is determined on the basis of the distance R in such a way that the visual angle θ is held to a given constant value.

For instance, in an information display apparatus 1 having a 50-inch display screen 2 and a text display area 2B of a size equal to a quarter of that of the display screen 2, each character is displayed by a default font that is formed by 24×24 dots if the user (viewer) is separated from the display screen 2 by distance R of 5 m. Then, when the user approaches to a position separated from the display screen 2 by distance of 2.5 m, the text to be displayed is so controlled that each character is displayed by a font that is formed by 12×12 dots. Thus, combinations of character size X and distance R are stored in the table 172 in such a way that each combination shows a given correlation.

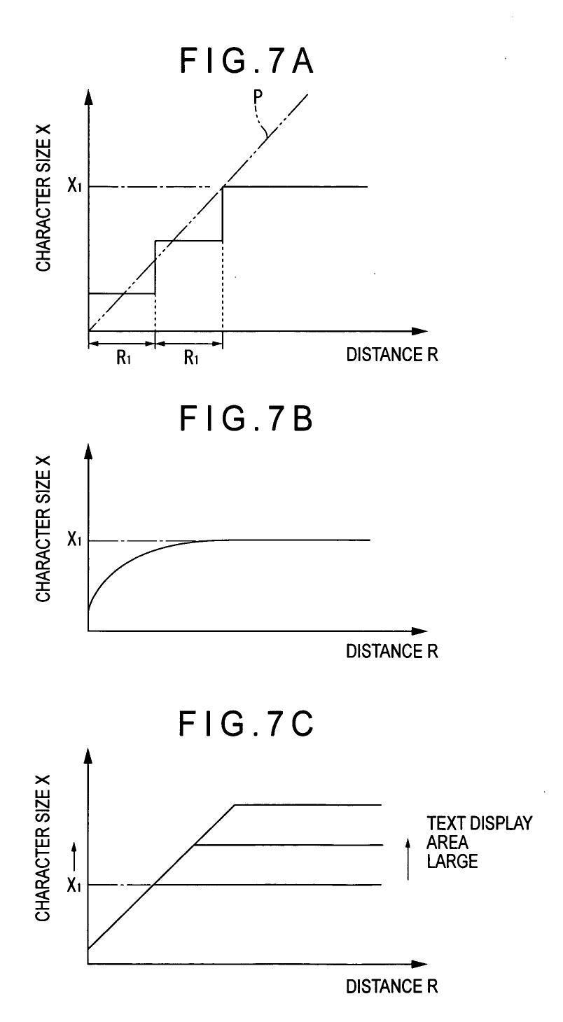

The correlation of the character size X and the distance R may be such that the character size X is linearly proportional to the distance R as indicated by the phantom line P in FIG. 7A or may be non-linear as indicated by the solid lines in FIGS. 7A through 7C. More specifically, the correlation of the character size X and the distance R may be such that the character size X increases stepwise each time the distance R increases by a given distance R1 to repeat a sudden rise and a plateau as indicated by the solid line in FIG. 7A. Alternatively, the correlation of the character size X and the distance R may be such that the rate at which the character size X changes is large when the distance R is relatively small but becomes small when the distance R becomes large as shown in FIG. 7B. The information display apparatus 1 is provided with a feature of limiter that limits the character size X to a predefined size X1 when the distance R is increased beyond a predetermined value. The feature of limiter is such that the limit of the size of characters displayed in the text display area 2B is defined on the basis of the number of characters arranged in a row.

If the distance R is increased and hence the size X of each character is increased, the number of characters that can be displayed on a row has to be reduced because the size of the text display area 2B is already defined in this embodiment.

As the number of characters that are displayed on a row is reduced, the viewer may feel it difficult to realize the text. Therefore, the smallest number of characters that are displayed in a row in the text display area 2B is predefined in this embodiment so that the character size X is not increased limitlessly if the distance R is increased.

Incidentally, the size X1 of characters that can be displayed in a row is increased when the area of the text display area 2B is enlarged as shown in FIG. 7C.

The setup unit 173 specifies the area of the text display area 2B, the background color of the text display area 2B, the maximum limit of the size X of each character to be displayed in the text display area 2B and the correlation of the character size X and the distance R (which of the graphs of FIGS. 7A through 7C is selected) and so on and has a memory for storing the specified values and so on. Any of the specified values can be modified or replaced by a signal from the remote controller 5.

The font determining unit 174 computes the current visual angle θ′ on the basis of the current distance R′ computed by the distance computing unit 171 and the data stored in the table 172 and compares the current visual angle θ′ and the visual angle θ that has been stored. Then, the font determining unit 174 transmits a signal to the driver 175 for modifying the character size X to X′ that makes the visual angles θ and θ′ agree with each other. The font determining unit 174 also updates the distance R, the visual angle θ and the character size X respectively to R′, θ′ and X′ as well as other related data.

The driver 175 receives the signal output from the remote controller 5 and the signal output from the font determining unit 174 and operates to respond to the received signals.

The manual driver 176 is used to manually change the size X of each character regardless of the distance R. When the manual driver 176 is in operation, the driver 175 is at rest.

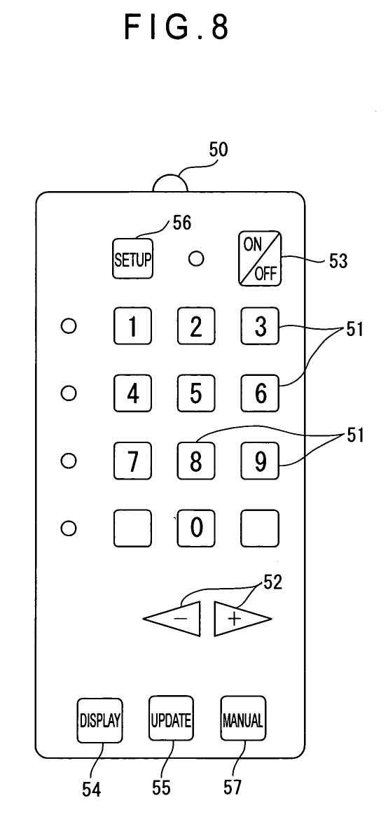

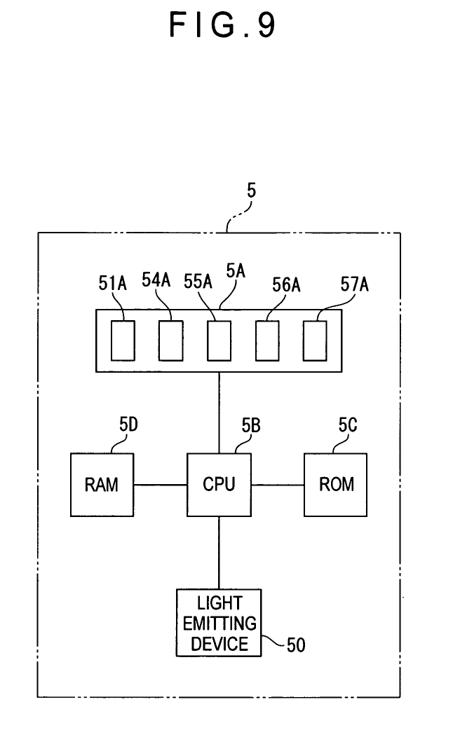

FIGS. 8 and 9 illustrate the configuration of the remote controller S.

Referring to FIG. 8 that shows an outer configuration of the remote controller 5, the remote controller 5 has program selection buttons 51, volume buttons 52, a power button 53, a text display button 54, a text update button 55, a setup button 56 and a manual button 57. The program selection buttons 51 also operate as ten keys that are typically used for initialization.

FIG. 9 shows a circuit configuration of the remote controller 5.

Referring to FIG. 9, a switch array 5A is formed by arranging switches 51A, 54A, 55A, 56A and 57A that correspond respectively to the program selection buttons 51, the text display button 54, the text update button 55, the setup button 56 and the manual button 57 and the drive circuit of the remote controller 5 is formed by the switch array 5A, a CPU 5B, a ROM 5C and a RAM 5D.

The CPU 5B receives signals from the switches 5A, 54A, 55A, 56A and 57A and transmits signals to the light emitting device 50, which transmits signals to the information display apparatus 1.

For instance, as the text display button 54 is pushed, the switch 54A is turned ON and the CPU 5B transmits a drive signal from the light emitting device 50 to the driver 175 of the CPU 17 of the information display apparatus 1. As a result, the text display area 2B appears in the display screen 2 and the size X of the characters to be displayed in the text display area 2B is automatically controlled according to the distance R.

Then, as the text update button 55 is pushed, the switch 55A is turned ON and the CPU 5B transmits a drive signal from the light emitting device 50 to the driver 175 of the CPU 17 of the information display apparatus 1. As a result, the text in the text display area 2B will be updated.

As the setup button 56 is pushed, the switch 56A is turned ON and the CPU 5B transmits a drive signal from the light emitting device 50 to the setup unit 173 of the CPU 17 of the information display apparatus 1. Thereafter, the user (viewer) can initialize the text display area 2B by using the program selection buttons 51 that also operate as ten keys and other buttons.

As the manual button 57 is pushed, the switch 57A is turned ON and the CPU 5B transmits a drive signal from the light emitting device 50 to the manual driver 176 of the CPU 17 of the information display apparatus 1. Thereafter, the user (viewer) can manually change the size X of the characters to be displayed in the text display area 2B by using the program selection buttons 51 and other buttons.

Now, the operation of the above-described embodiment will be discussed below.

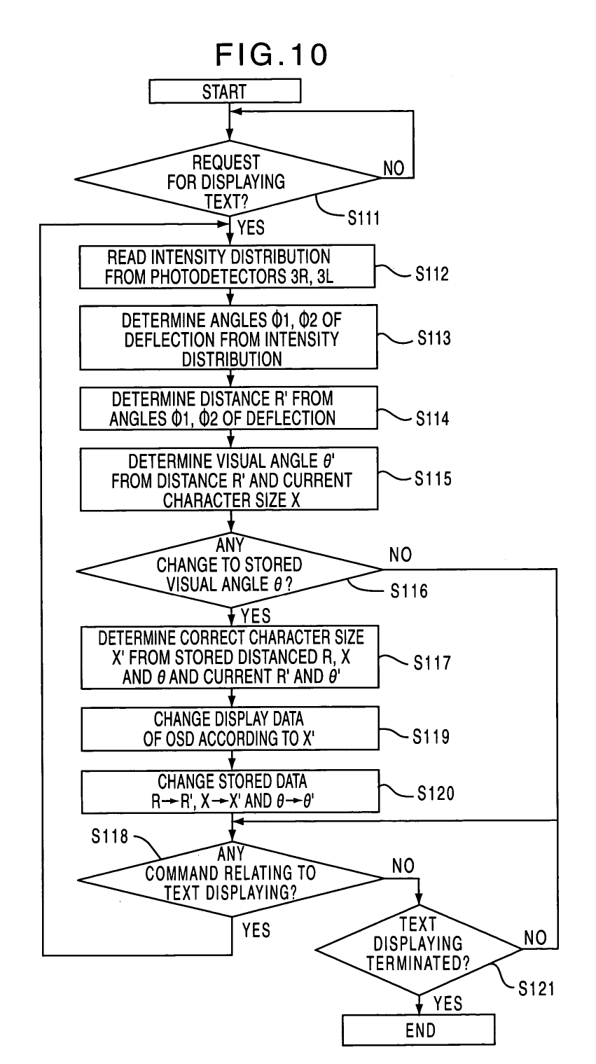

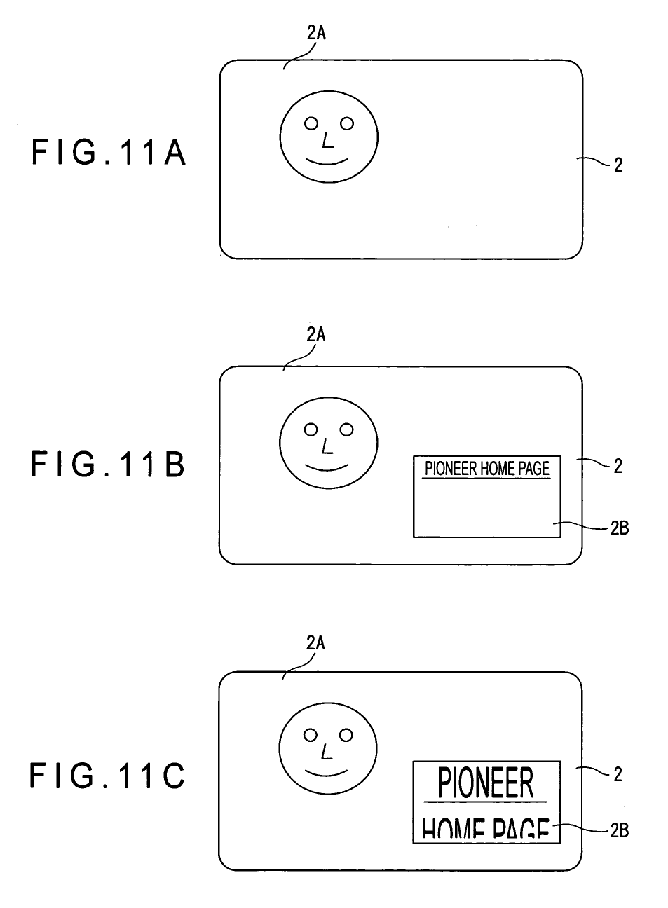

The basic procedure for controlling the character size X as a function of the distance R in a simple manner will be described by referring to FIGS. 10 and 11A through 11C.

FIG. 10 is a flowchart showing procedure for simply controlling the size of the characters to be displayed.

Firstly, as the text display button 54 of the remote controller 5 is pushed, the switch 54A is turned ON to generate a signal and the generated signal is transmitted to the driver 175 of the CPU 17 of the information display apparatus 1. As the signal is transmitted to the driver 175, the text display area 2B appears on the display screen 2 as shown in FIG. 11B where only the image display area 2A has been visible as shown in FIG. 11A.

As shown in FIG. 10, as the text display button 54 is pushed, a request for displaying a text is issued (S111) and the optical signal transmitted from the light emitting device 50 of the remote controller 5 is received by the photodetectors 3R, 3L, which read the distribution of intensity of received light (S112).

Then, the CPU 17 of the information display apparatus 1 determines the angles Φ1, Φ2 of deflection from the distribution of intensity of light (S113). The CPU 17 then determines the actual distance R′ between the remote controller 5 and the information display apparatus 1 from the angles Φ1, Φ2 of deflection (S114).

The CPU 17 then determines the current visual angle θ′ on the basis of the current distance R′ and the current size X′ of each character (S115). Then, the CPU 17 determines if the visual angle θ′ differs from the stored visual angle θ or not (S116). If the answer to this question is YES, the CPU 17 determines the character size X′ to be specified on the basis of the stored values of the distance R, the character size X and the visual angle θ and the current values of the distance R′ and the visual angle θ′ (S117). If, on the other hand, the answer to the question is NO, the CPU 17 determines if there is any received command relating to text displaying or not (S118).

When the character size X′ to be specified is determined, the CPU 17 transmits a signal representing the data to be used for displaying the text to the OSD according to the value of X′ (S119) and updates the stored data R, θ and X respectively to R′, X′ and θ′ (S120).

If, for instance, the current distance R′ is greater than the stored distance R, a larger character size X will be specified for each character as shown in FIG. 11C.

When the stored data are updated, the CPU 17 determines if there is any received command relating to text displaying or not (S118) and returns to the Step S112 if the answer to this question is YES, whereas the CPU 17 determines if the operation of displaying the text is over or not (S121) if the answer to the question is NO. Then, the CPU 17 terminates the control system if the operation of displaying the text is over, whereas the CPU 17 returns to the Step S118 if the operation is not over yet.

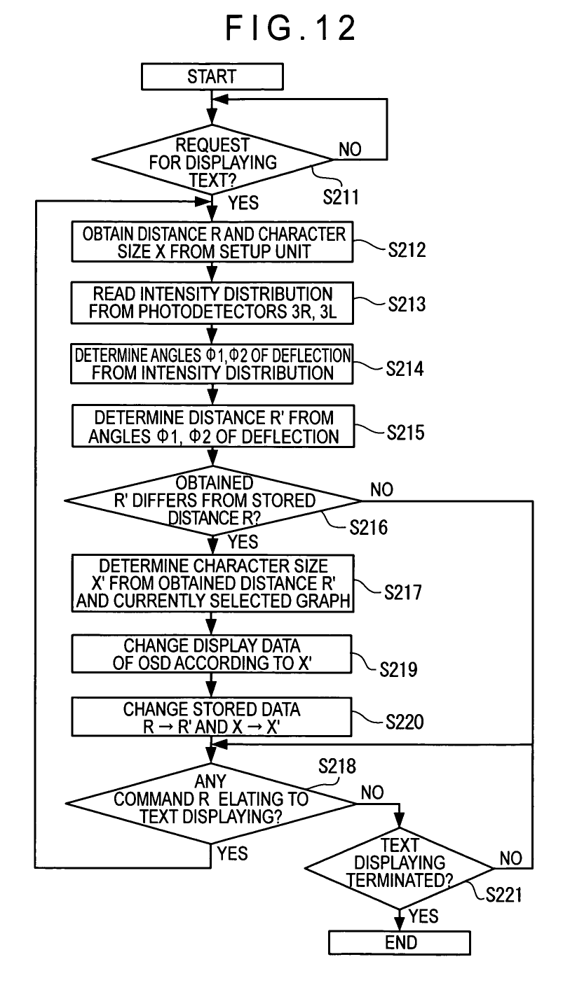

Now, the procedure for controlling the character size X as a function of the distance R according to a non-linear graph (any of the solid line graphs in FIGS. 7A through 7C) will be described by referring to FIG. 12.

FIG. 12 is a flowchart showing the procedure for controlling the size of the displayed characters according to a non-linear graph.

Firstly, the CPU 17 determines if there is a request issued for displaying a text or not (S211). If there is a request for displaying a text, the CPU 17 obtains data on the distance R and the character size X from the setup unit 173 (S212). Then, the CPU 17 receives the optical signal transmitted from the light emitting device 50 of the remote controller 5 by the photodetectors 3R, 3L, which read the distribution of intensity of received light (S213). The CPU 17 then determines the angles Φ1, Φ2 of deflection from the distribution of intensity of light (S214). The CPU 17 then determines the actual distance R′ between the remote controller 5 and the information display apparatus 1 from the angles Φ1, Φ2 of deflection (S215).

The CPU 17 then compares the stored distance R and the current distance R′ (S216). If the distance R and the distance R′ differ from each other, the CPU 17 then determines the character size X′ on the basis of the obtained current distance R′ and the currently selected graph (S217). If, on the other hand, the distance R and the distance R′ do not differ from each other, the CPU 17 further determines if there is any received command relating to text displaying or not (S218).

When the character size X′ to be specified is determined, the CPU 17 transmits a signal representing change of the data to be used for displaying the text to the OSD according to the value of X′ (S219) and updates the stored data R, θ and X respectively to R′, X′ and θ′ (S220).

When the stored data are updated, the CPU 17 determines if there is any received command relating to text displaying or not (S218) and returns to the Step S212 if the answer to this question is YES, whereas the CPU 17 determines if the operation of displaying the text is over or not (S221) if the answer to the question is NO. Then, the CPU 17 terminates the control system if the operation of displaying the text is over, whereas the CPU 17 returns to the Step S218 if the operation is not over yet.

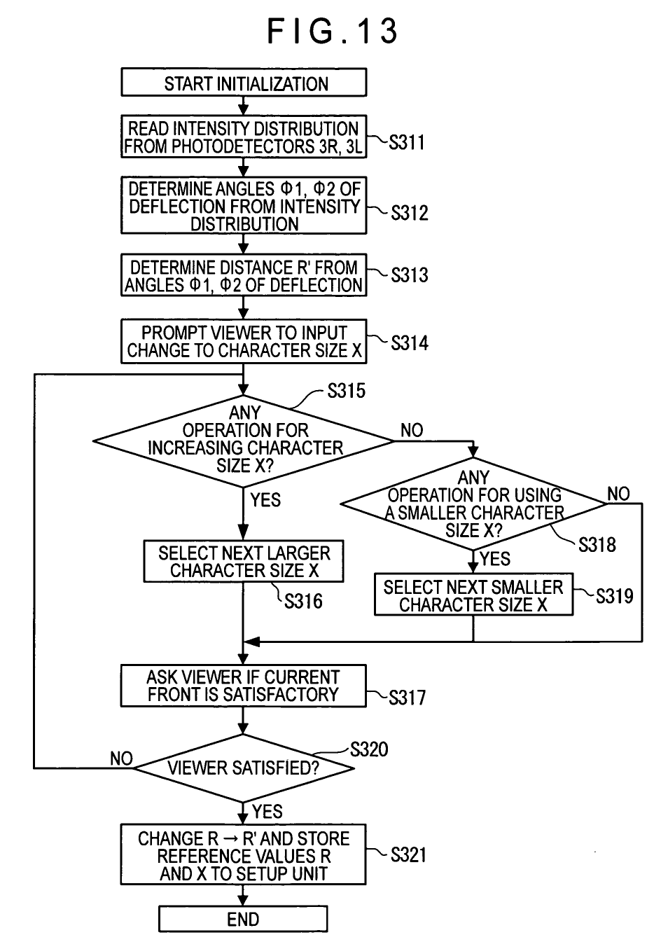

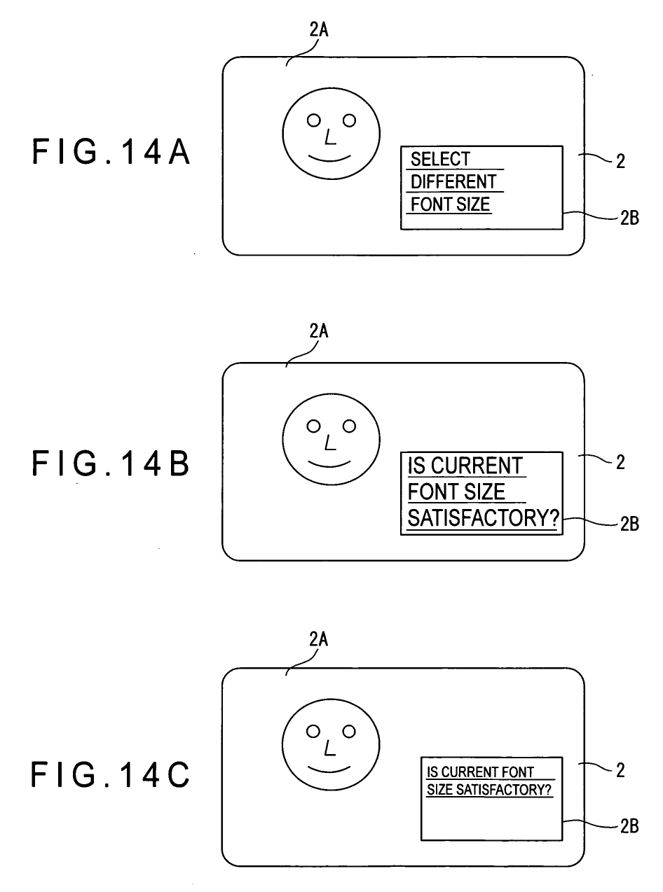

Now, procedure for initialization will be described by referring to FIGS. 13 and 14A through 14C.

FIG. 13 is a flowchart showing the procedure for initializing the size of the characters to be displayed.

Firstly, as the setup button 56 of the remote controller 5 is pushed, the switch 56A is turned ON and the signal representing the ON of the switch 56A is transmitted to the setup unit 173 of the CPU 17 of the information display apparatus 1.

Then, the optical signal transmitted from the light emitting device 50 of the remote controller 5 is received by the photodetectors 3R, 3L, which read the distribution of intensity of received light (S311). Further, the CPU 17 of the information display apparatus 1 determines the angles Φ1, Φ2 of deflection from the distribution of intensity of light (S312). The CPU 17 then determines the actual distance R′ between the remote controller 5 and the information display apparatus 1 from the angles Φ1, Φ2 of deflection (S313) and prompt the user to change the size of the characters to be displayed (S314). In this case, a message “Change the font size.” is displayed in the text display area 2B in the display screen 2 as shown in FIG. 14A.

Thereafter, the CPU 17 determines if there has been an operation for increasing the character size X or not (S315). If it is determined that there has been such an operation, the CPU 17 selects the next larger font (S316) and asks the user (viewer) if the current font is satisfactory or not (S317). In this case, a message “Is the font size satisfactory?” is displayed in the text display area 2B in the display screen 2 as shown in FIG. 14B.

If it is determined that there has not been any operation for increasing the character size X, the CPU 17 then determines if there has been an operation for decreasing the character size X or not (S318). If it is determined that there has been such an operation, the CPU 17 selects the next smaller font (S319) and asks the user (viewer) if the current font is satisfactory or not (S317). In this case, a message “Is the font size satisfactory?” is displayed in the text display area 2B in the display screen 2 as shown in FIG. 14B.

If it is determined that there has not been any operation for decreasing the character size X, the CPU asks the user (viewer) if the current font size is satisfactory or not (S317).

When the CPU 17 receives from the user (viewer) a signal representing YES to the message shown in FIG. 14B by the remote controller 5 (S320), the CPU 17 changes the reference value R to the value of the current distance R′ and selects the value of the size X as reference value, which is then stored in the setup unit with the reference distance R (S321) to terminate the operation. If the CPU 17 does not receive from the user (viewer) any signal representing YES to the message, the CPU 17 returns to the Step S315.

Thus, the present embodiment provides the following advantages.

(1) Since the information display apparatus 1 having the text display area 2B for displaying a text according to the signal transmitted from the remote controller 5 includes the distance measuring unit 6 for measuring the distance between the apparatus and the remote controller 5 and the CPU 17 for determining the size X of the characters to be displayed in the text display area 2B with the predetermined optimal size of characters based on the result of the distance measuring unit 6 according to the predetermined relationship between distance R from the apparatus to the remote controller 5 and optimal size X of the characters, and since the user of the remote controller 5 is located at the position where the user watches the information display apparatus 1, the user is freed from the inconvenience of manually changing the size of the characters to be displayed in the text display area 2B because the size X of the characters to be displayed in the text display area 2B is automatically and optimally controlled by the distance measuring unit 6 and the CPU 17 according to the distance R between the remote controller 5 and the information display apparatus 1.

(2) Since the remote controller 5 includes the light emitting device 50 that outputs an optical signal for measuring the distance R and the distance measuring unit 6 is an optical range finder that measures the distance R by receiving the optical signal output from the remote controller 5, it is possible to accurately measure the distance R and thereby accurately control the character size, because light is used as distance measuring unit.

(3) Since the optical range finder has the pair of photodetectors 3R, 3L arranged oppositely with the text display area 2B interposed between them and the distance R is computationally determined on the basis of the triangle defined by the photodetectors 3R, 3L and the remote controller 5 as the shortest line segment connecting a point on the line segment connecting the photodetectors 3R, 3L and the remote controller 5, it is possible to accurately determine the distance R between the user (viewer) and the information display apparatus 1 by using a formula defined on the basis of the relationship of the triangle if the user (viewer) is not located right in front of the information display apparatus 1 and hence it is possible to accurately control the character size X on the basis of the accurately determined distance R.

(4) Since the information display apparatus 1 has the image display area 2A for displaying images and the text display area 2B, it is possible to supplement the image in the image display area 2A with the text displayed in the text display area 2B and hence it is possible to use the information display apparatus 1 to display a variety of pieces of information.

(5) When the CPU 17 is configured to control the size X of the characters to be displayed in the text display area 2B so as to be linearly proportional to the distance R between the information display apparatus 1 and the remote controller 5, it is possible to delicately change the character size X to correspond to the distance R.

(6) When the CPU 17 is configured to control the size X of the characters to be displayed in the text display area 2B so as to increase stepwise each time the distance R between the apparatus 1 and the remote controller 5 increases by a given distance to repeat a sudden rise and a plateau, the size X of the characters to be displayed in the text display area 2B does not change at all if the user (viewer) changes his or her posture to slightly change the distance between the information display apparatus 1 and the remote controller 5 so that the user (viewer) does not feel any inconvenience in viewing the characters being displayed in the text display area 2B.

(7) When the CPU 17 is configured to control the size of the characters to be displayed in the text display area 2B in such a way that the rate at which the character size X changes is large when the distance R is relatively small but becomes small when the distance R becomes large, the character size X changes remarkably in a near distance zone where the text being displayed in the text display area 2B is viewed relatively frequently so that the character size can be controlled in a rational way.

(8) Since the CPU 17 has a feature of limiter that limits the size of the characters to be displayed in the text display area 2B to a predefined size when the distance R between the information display apparatus 1 and the remote controller 5 is increased beyond a predetermined value, it is possible to avoid the inconvenience that the user cannot realize the text being displayed in the text display area 2B because the characters of the text are too large.

(9) Since the CPU 17 determines the limit of the size of the characters displayed in the text display area 2B on the basis of the number of characters arranged in a row, the text being displayed in the text display area 2B can reliably be realized by the user (viewer).

(10) Since the CPU 17 includes the manual driver 176 to manually and optimally change the size of each character to be displayed in the text display area 2B in response to a signal from the remote controller 5, the user (viewer) can select an automatic control mode and a manual control mode for the character size X to a greater convenience on the part of the user (viewer).

(11) Since the pair of photodetectors 3R, 3L are arranged horizontally with the display screen 2 interposed between them, the distance separating them can be made relatively large so that the character size X can be accurately controlled even if the user (viewer) is not right in front of the display screen 2. More specifically, the information display apparatus 1 is a television set and the display screen 2 of the television set has an aspect ratio greater than 1 and hence the width of the display screen 2 is greater than the height thereof. Thus, the distance separating the photodetectors 3R, 3L can be greater when they are arranged in a horizontal direction than when they are arranged in a vertical direction. As the distance separating the photodetectors 3R, 3L increases, the angle Φ increases so that the distance between the display screen 2 and the user (viewer or the remote controller 5) can be accurately measured to accurately control the character size.

(12) Since the CPU 17 includes the setup unit 173 for specifying the area of the text display area 2B, the background color of the text display area 2B, the maximum limit of the size of each character to be displayed in the text display area 2B and the correlation of the character size X and the distance R, the user (viewer) can select a font size that is optimal to him or her. For example, a user (viewer) who is handicapped in terms of visual sense can select a font size larger than the font size that is optimal to a user (viewer) who has a normal visual sense.

The present invention is by no means limited to the above-described embodiment, which may be modified or improved in various different ways without departing from the scope of the present invention.

For example, while two photodetectors 3R, 3L are arranged with the text display area 2B interposed between them in the above-described embodiment. However, the number of photodetectors 3R, 3L is not limited to two for the purpose of the present invention and the number of photodetectors may be one. Alternatively, it may be three or more than three.

For example, only either one of the two photodetectors 3R, 3L may be selectively used if the user (viewer) operates the remote controller 5 right in front of the text display area 2B. If two photodetectors are provided, the direction of arrangement of the photodetectors is not limited to that of the above-described embodiment. Alternatively, the two photodetectors 3R, 3L may be arranged vertically with the display screen 2 interposed between them.

Means other than light such as ultrasonic wave may alternatively be used to measure the distance R.

It may alternatively be so arranged that the information display apparatus 1 has only a text display area 2B. If such is the case, it may be so arranged that the information display apparatus 1 outputs a sound from the loudspeaker and a text that corresponds to the sound is displayed on the text display area 2B.

While the information display apparatus 1 is a television set in the above description, the information display apparatus 1 may alternatively be an apparatus other than a television set. For example, the information display apparatus 1 may be a projector. The information display apparatus 1 may have any configuration so long as the apparatus 1 can be operated by the remote controller 5.

While characters are arranged horizontally in the text display area 2B in the above description, they may alternatively be arranged vertically.

What is claimed is:

1. An information display apparatus having a text display area for displaying a text according to the signal transmitted from a remote controller, the apparatus comprising:
a distance measuring unit for measuring the distance between the apparatus and the remote controller; and
a control unit for determining the size of the characters to be displayed in the text display area with the predetermined optimal size of characters based on the result of the distance measuring unit according to the predetermined relationship between distance from the apparatus to the remote controller and optimal size of the characters.

2. The apparatus according to claim 1,
wherein the remote controller outputs an optical signal for measuring the distance, and
wherein the distance measuring unit is an optical range finder to measure the distance by receiving the optical signal output from the remote controller.

3. The apparatus according to claim 2, wherein the optical range finder has two photodetectors arranged at respective positions with the text display area interposed between them and measures the distance on the basis of the triangle defined by the photodetectors and the remote controller, as the shortest line segment connecting a point on the line segment connecting the photodetectors and the remote controller.

4. The apparatus according to claim 1, further comprising an image display area for displaying an image in addition to the text display area.

5. The apparatus according to claim 1, wherein the size of the characters to be displayed in the text display area is so controlled by the control unit as to be linearly proportional to the distance between the information display apparatus and the remote controller.

6. The apparatus according to claim 1, wherein the size of the characters to be displayed in the text display area is so controlled by the control unit as to change stepwise each time the distance changes by a given distance to repeat a sudden rise and a plateau.

7. The apparatus according to claim 1, wherein the size of the characters to be displayed in the text display area is controlled by the control unit in such a way that the rate at which the character size changes is large when the distance is relatively small but becomes small when the distance becomes large.

8. The apparatus according to claim 1, wherein the control unit limits the size of the characters to be displayed in the text display area to a predefined size when the distance between the information display apparatus and the remote controller is increased beyond a predetermined value.

9. The apparatus according to claim 8, wherein the control unit determines the limit of the size of the characters displayed in the text display area on the basis of the number of characters arranged in a row.

10. The apparatus according to claim 1, wherein the control unit comprises a manual driver to manually and optimally control the size of each character to be displayed in the text display area in response to a signal from the remote controller.

11. An information display method for displaying a text according to a signal transmitted from a remote controller, the method comprising the steps of:
determining the size of the characters to be displayed in the text display area with the predetermined optimal size of characters based on the result of the distance measuring unit according to the predetermined relationship between distance from the apparatus to the remote controller and optimal size of the characters.
